(19) United States
(12) Patent Application Publication
(10) Pub. No.: US 2020/0324363 A1
(43) Pub. Date: Oct. 15, 2020

(54) SYSTEM AND METHOD FOR JOINING LIGHT METAL SHEETS

(71) Applicants: Timothy A. ABKE, Raymond, OH (US); Duane Trent DETWILER, Raymond, OH (US); Honda Motor Co., Ltd., Tokyo (JP)

(72) Inventors: Timothy A. Abke, Dublin, OH (US); Duane Trent Detwiler, Powell, OH (US)

(21) Appl. No.: 16/610,665

(22) PCT Filed: Jun. 6, 2018
(86) PCT No.: PCT/US2018/036238

§ 371 Date: Nov. 4, 2019

Related U.S. Application Data
(60) Provisional application No. 62/518,025, filed on Jun. 12, 2017.

(51) Int. Cl. B23K 20/12

(52) U.S. Cl. CPC B23K 20/129; B21J 15/027; B23K 20/122

(57) ABSTRACT

A system and method for joining multiple lightweight metal sheets to a steel sheet through friction welding that include rotating and moving a first fastener along a fastener axis towards a first workpiece, wherein the first workpiece includes a lightweight metal sheet. The system and method also include contacting the first workpiece and driving the first fastener through the first workpiece and a second workpiece. The system and method further include joining the second fastener and completing friction welding.

### CROSS-REFERENCE TO RELATED APPLICATION

This application is a national stage application, filed under 35 U.S.C. 371, of International Patent Application No. PCT/US2018/036238, filed on Jun. 6, 2018, which claims the benefit of U.S. Provisional Patent Application No. 62/518,025, filed on Jun. 12, 2017, each of which is incorporated by reference herein in its entirety.

### BACKGROUND

Friction element welding joining techniques are generally used to create a metallurgical bond between two or more lightweight metal sheets and a steel sheet. Currently most friction element welding joining techniques do not allow the joining of multiple thicknesses of high strength metallic materials. Alternative techniques to friction element welding such as a self-piercing riveting technique are currently utilized for joining high strength metallic materials. However, such techniques often require changing of a die and offer a limited range of joining capability.

### BRIEF DESCRIPTION

According to one aspect, a method for joining multiple lightweight metal sheets to a steel sheet through friction welding that includes rotating and moving a first fastener along a fastener axis towards a first workpiece. The first workpiece includes a lightweight metal sheet. The first workpiece includes an aluminum sheet or a magnesium sheet. The method also includes contacting the first workpiece and driving the first fastener through the first workpiece and a second workpiece. The second workpiece includes a second lightweight metal sheet that is disposed upon a second fastener. The second workpiece includes an aluminum sheet or a magnesium sheet. The method further includes joining the second fastener and completing friction welding. The first fastener is driven through the first workpiece and the second workpiece by friction stirring. The first fastener and the second fastener are welded to form a metallurgical bond and join the first workpiece with the second workpiece.

According to another aspect, a system for joining multiple lightweight metal sheets to a steel sheet through friction welding that includes a first fastener that is rotated and moved along a fastener axis. The system also includes a first workpiece and a second workpiece. The first workpiece and the second workpiece include a lightweight metal sheet. The first workpiece and the second workpiece include an aluminum sheet or a magnesium sheet. The first fastener is driven through the first workpiece and the second workpiece. The system additionally includes a second fastener that engages the second workpiece while the first fastener is driven through the first workpiece and the second workpiece. The first fastener is driven through the first workpiece and the second workpiece by friction stirring. The first fastener and the second fastener are welded to form a metallurgical bond and join the first workpiece with the second workpiece.

According to still another aspect, a system for joining multiple lightweight metal sheets to a steel sheet through friction welding that includes a first steel fastener that friction stirs through multiple sheets of high strength lightweight metal. The system additionally includes a second steel fastener that is positioned opposite the first steel fastener. A surface of the second steel fastener is engaged by the first steel fastener and the first steel fastener is welded to the surface of the second steel fastener and joins the multiple sheets of high strength lightweight metal.

### BRIEF DESCRIPTION OF THE DRAWINGS

FIG. 1 is a schematic exploded view of components of a friction element welding system, according to an exemplary embodiment;

FIG. 2 is a schematic exploded cross-sectional view of the friction element welding system that includes a first fastener and a second fastener welded to join the first workpiece and the second workpiece, according to an exemplary embodiment;

FIG. 3. is a process flow diagram of a method for joining multiple lightweight metal sheets through friction welding, according to an exemplary embodiment;

FIG. 4A is a schematic exploded cross-sectional view of the friction welding device that includes the first fastener as it approaches the second fastener;

FIG. 4B is a schematic exploded cross-sectional view of the friction welding device that includes the first fastener penetrating through the first workpiece and the second workpiece, according to an exemplary embodiment;

FIG. 4C is a schematic exploded cross-sectional view of the friction welding device that includes the first fastener contacting a flat surface of the second fastener, according to an exemplary embodiment; and

FIG. 4D is a schematic exploded cross-sectional view of the friction welding device that includes the first fastener and the second fastener being welded to form a metallurgical bond and join the first workpiece with the second workpiece.

### DETAILED DESCRIPTION

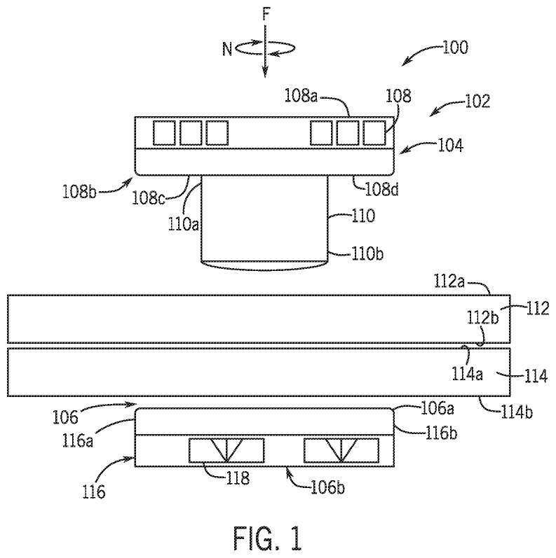

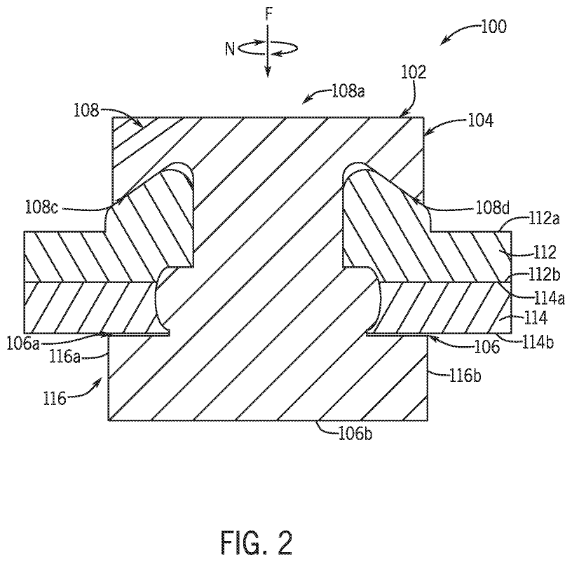

Referring now to the drawings, wherein the showings are for purposes of illustrating one or more exemplary embodiments and not for purposes of limiting the same, FIGS. 1 and 2 show a friction welding system according to an exemplary embodiment and generally indicated by reference numeral 100. As will be described in more detail herein, the friction welding system 100 includes a friction welding device 102 that is utilized to join multiple lightweight metal sheets by a friction element welding process. The friction welding device 102 may also be utilized to join multiple high strength metal sheets. For example, the friction welding device 102 can be utilized to join multiple sheets of aluminum (e.g., type 7075), and/or magnesium or could be used to join multiple metal sheets of different materials.

The friction welding device 102 of the illustrated embodiment may include a first fastener 104. The friction welding device 102 may additionally include a second fastener 106 that is disposed opposite the first fastener 104. As described in more detail below, the first fastener 104 is movable and includes a head 108 and a shaft 110. The first fastener 104 may engage a first sheet of material, herein referred to as a first workpiece 112 to further join the first workpiece 112 to a second sheet of material, herein referred to a second workpiece 114.

In an exemplary embodiment, the second fastener 106 may include a flat surface 106a. The flat surface 106a is configured to engage a second portion 114b of the second workpiece 114. In one or more embodiments, the second fastener 106 may be shaped and configured to be placed within an anvil (e.g., lower die of a welding machine) (not shown in FIG. 1). As discussed below, the second fastener 106 includes one or more locking elements 118 that may be included as teeth that are configured to lock and center the second fastener 106 within the anvil. Consequently, when the second fastener 106 is positioned within the anvil, rotation of the second fastener 106 is avoided while the first fastener 104 is rotated during the friction element welding process.

Referring specifically to the first fastener 104, in one embodiment, the first fastener 104 may be wholly or partially made of steel. The head 108 of the first fastener 104 is disposed above the shaft 110. The head 108 includes a width that defines a first head portion 108a and a second head portion 108b opposite the first head portion 108a. The head 108 may be configured to allow a motorized tool (not shown) to rotate the first fastener 104. The motorized tool may rotate the first fastener 104 in the rotational direction N (designated in FIGS. 1 and 2) at a predetermined RPM (e.g., 3000 RPM) that may be regulated by the tool itself or an external controller (not shown). The head portion 124 may be configured in various shapes, that include, but are not limited to, a polygonal shape, a flat shape, an oval shape, and a round shape. In an exemplary embodiment, the first head portion 108a may include, but may not be limited to, a polygonal, partially-polygonal, concave, and/or convex structure which may be operably connected to the motorized tool to allow rotation of the first fastener 104 while minimizing the risk of slippage during rotation. In some embodiments, the first head portion 108a includes one or more grooves that are configured to detachably engage with the motorized tool.

The second head portion 108b may include a first lower fastening portion 108c and a second lower fastening portion 108d that are configured and sized to hold extruded/displaced metal upset from the first workpiece 112 caused by friction stirring. It is to be appreciated that the second head portion 108b, the first lower fastening portion 108c, and the second lower fastening portion 108d may be configured in various suitable shapes that may be sized to hold the extruded/displaced metal upset from the first workpiece 112.

In an exemplary embodiment, the shaft 110 is generally cylindrical in shape and is coupled to the second head portion 108b at a first end 110a. In particular, the shaft 110 is disposed between the first lower fastening portion 108c and the second lower fastening portion 108d of the head 108. The shaft 110 additionally includes a second end 110b that is disposed opposite the first end 110a.

The shaft 110 extends along an axis F (designated in FIGS. 1 and 2) and protrudes towards the head 108 and the first workpiece 112. Additionally, the shaft 110 is generally perpendicular to the first workpiece 112, the second workpiece 114, and the second fastener 106. In one embodiment, the second end 110b of the shaft 110 is composed of steel. The second end 110b may be used to drive the first fastener 104 through the first workpiece 112 and second workpiece 114. As discussed below, the shaft 110 may be driven through the first workpiece 112 and the second workpiece 114 until it joins with the flat surface 106a of the second fastener 106 as the first fastener 104 is rotated and lowered along the axis F.

With continued reference to FIG. 1, the second end 110b of the shaft 110 is positioned above a first portion 112a of the first workpiece 112. Additionally, the first workpiece 112 is placed above the second workpiece 114, thereby causing pressure exhibited by the first fastener 104 to be provided upon the first and second workpieces 112, 114 as the first fastener 104 is lowered along the axis F during the friction element welding process.

In an exemplary embodiment, the first workpiece 112 may include one or more light weight metallic sheets that may be composed of a high strength metallic material that may include a substantially planar shape. For example, the first workpiece 112 may include, but is not limited to an aluminum workpiece, or a magnesium workpiece. In addition to being placed below the first workpiece 112, the second workpiece 114 may be placed upon and may engage the flat surface 106a of the second fastener 106. In one or more embodiments, the second workpiece 114 may include one or more light weight metallic sheets that may be composed of high strength metallic materials that may also include a substantially planar shape. The second workpiece 114 may include, but is not limited to an aluminum workpiece, a magnesium workpiece, or a steel workpiece.

With specific reference to the second fastener 106, in one embodiment, the second fastener 106 may be wholly or partially made of steel. In an exemplary embodiment, the flat surface 106a of the second fastener 106 is composed of steel. The flat surface 106a is configured to directly engage the second end 110b of the shaft of the first fastener 104 during the friction element welding process. In particular, the second workpiece 114 may be joined to the first workpiece 112 based on friction welding of the second end 110b of the shaft 110 of the first fastener 104 and the flat surface 106a of the second fastener 106 that is completed during the friction element welding process, described below.

The second fastener 106 additionally includes a head 116 that includes side surfaces 116a, 116b that interconnect the flat surface 106a to a base portion 106b that is disposed opposite of the flat surface 106a. The head 116 may be shaped and configured such that it may be operably centered in position within the anvil.

In one embodiment, the head 116 may include the one or more locking elements 118 that may be placed within a locked mode to enable the second fastener 106 to be fixed in place and centered during operation of the friction welding device 102. In other words, the locking element(s) 118 may ensure that the second fastener 106 does not rotate when the first fastener 104 is rotated and is pushed towards the workpieces 112, 114 during the friction element welding process.

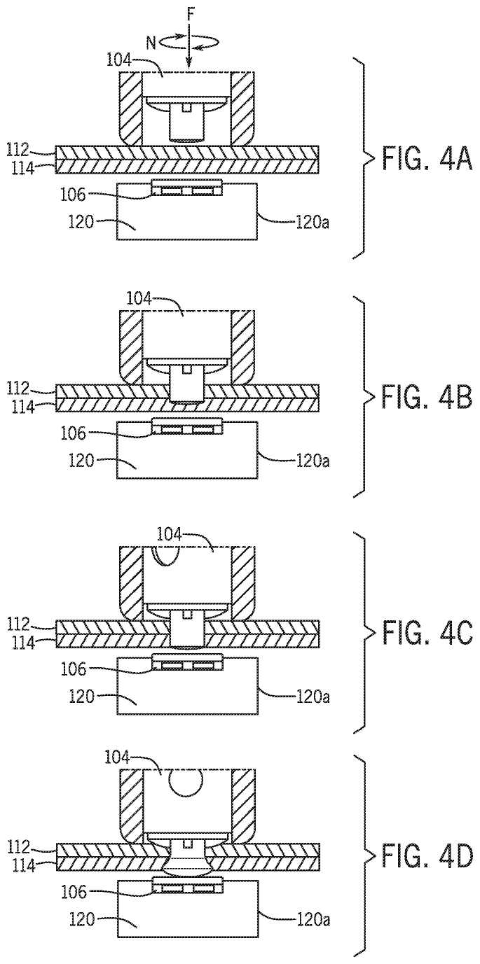

Referring to FIG. 4A-4D, in one or more embodiments, the anvil 120 includes a cutout 120a that is configured to positon the head 116 of second fastener 106 in a fixed and centered position. In one embodiment, the cutout 120a may include serrations (e.g., grooves) (not shown) that may be utilized to operably connect to the locking element(s) 118 to lock the second fastener 106 in place when it is positioned within the anvil 120. In another embodiment, the cutout 120a may be configured as including smooth inner surfaces. In an exemplary embodiment, when the second fastener 106 is placed within the anvil 120, the second fastener 106 is immovable and centered to align the second fastener 106 with the first fastener 104 along the axis F. The anvil 120 may be utilized to support the overall weight of the first fastener 104, the second fastener 106, the first workpiece 112, and the second workpiece 114 as the friction element welding process takes place.

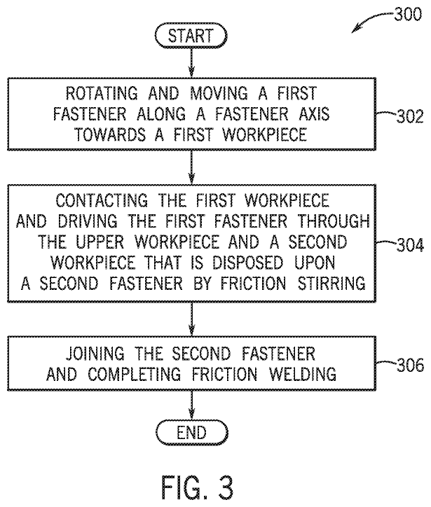

The friction element welding process will now be discussed in more detail with reference to FIG. 3A, a process flow diagram of a method 300 for joining multiple lightweight metal sheets through friction welding. FIG. 3 will be described with reference to the components of FIGS. 1 and 2, though it is to be appreciated that the method of FIG. 3 may be used with other systems/components. The method 300 may begin at block 302, wherein the method 300 includes rotating and moving a first fastener 104 along a fastener axis towards a first workpiece 112. As discussed above, a motorized tool may be operably connected to the head 108 of the first fastener 104 to rotate the first fastener 104 in the rotational direction N. With reference to FIG. 4A, the first fastener 104 is lowered towards the first portion 112a of the first workpiece 112.

Referring again to FIG. 3, the method 300 may proceed to block 304, wherein the method 300 includes contacting the first workpiece 112 and driving the first fastener 104 through the first workpiece 112 and a second workpiece 114 that is disposed upon a second fastener 106 by friction stirring. With reference to FIGS. 1, 4A and 4B, in one embodiment, the movable first fastener 104 makes contact with the first workpiece 112. Through friction stirring the first fastener 104 penetrates the first workpiece 112 and the second workpiece 114 disposed upon the flat surface 106a of the second fastener 106 along the fastener axis F.

The first fastener 104 continues to be lowered along the axis F while being rotated in the rotational direction N. The rotation of the movement of the first fastener 104 during friction stir heats and soften portions of the first workpiece 112 and the second workpiece 114. The frictional heat may allow penetration of the first and second workpieces 112, 114 without pre-hole operation or melting. In particular, upon rotating, the first fastener 104 friction stirs through the first workpiece 112. More specifically, the second end 110b of the shaft 110 of the first fastener 104 is initially driven through the first portion 112a of the first workpiece 112 and then the second portion 112b of the first workpiece 112. The first fastener 104 is then driven through the first portion 114a of the second workpiece 114. Through continued friction stir, the first fastener 104 may continue to be driven through the second workpiece 114.

Referring again to FIG. 3, the method 300 may proceed to block 306, wherein the method 300 includes joining the second fastener and completing friction welding. Referring to FIGS. 4C and 4D, in one embodiment, upon penetrating through the first workpiece 112 and the second workpiece 114, the first fastener 104 penetrates through the second portion 114b of the second workpiece 114 and thereby contacts the flat surface 106a of the second fastener 106. Upon making contact with the flat surface 106a, pressure is applied by the first fastener 104 towards the second fastener 106.

The first fastener 104 and the second fastener 106 are friction welded to form a strong metallurgical bond between the first fastener 104 and the second fastener 106. This bond consequently joins the first workpiece 112 and the second workpiece 114 upon the application of pressure by the first fastener 104 upon the first workpiece 112, the second workpiece 114, and the second fastener 106. As represented in FIG. 2, the friction element welding process is used to join the first workpiece 112 and the second workpiece 114 that may both be comprised of lightweight metal/high strength lightweight metal sheets (e.g. solution treated and artificially aged 7075 aluminum). Therefore, the friction element welding process may join materials that may be dissimilar and may not be capable of being welding.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended the scope be defined by the claims appended hereto. Additionally, the features of various implementing embodiments may be combined to form further embodiments.

1. A method for joining multiple lightweight metal sheets to a steel sheet through friction welding, the method comprising:
rotating and moving a first fastener along a fastener axis towards a first workpiece, wherein the first workpiece includes a lightweight metal sheet, wherein the first workpiece includes an aluminum sheet or a magnesium sheet;
contacting the first workpiece and driving the first fastener through the first workpiece and a second workpiece, wherein the second workpiece includes a second lightweight metal sheet that is disposed upon a second fastener, wherein the second workpiece includes an aluminum sheet or a magnesium sheet; and
joining the second fastener and completing friction welding, wherein the first fastener is driven through the first workpiece and the second workpiece by friction stirring, wherein the first fastener and the second fastener are welded to form a metallurgical bond and join the first workpiece with the second workpiece.

2. The method of claim 1, wherein the first workpiece and the second workpiece include high strength lightweight metal sheets.

3. The method of claim 1, wherein rotating and moving the first fastener includes connecting a head of the first faster to a motorized tool to rotate the first fastener in a predetermined rotational direction at a predetermined speed.

4. The method of claim 1, wherein the second fastener includes a flat surface that is configured to engage a second surface of the second workpiece.

5. The method of claim 4, wherein the first fastener is moved and rotated to friction stir through the first workpiece and the second workpiece, wherein the friction stirring causes heating and softening of portions of the first workpiece and the second workpiece.

6. The method of claim 5, wherein the first fastener penetrates a first and second surface of the first workpiece and a first and second surface of the second workpiece to come in contact with a first surface of the second fastener.

7. The method of claim 1, further including an anvil that includes a cutout that is configured to accept a head of the second fastener.

8. The method of claim 1, wherein the second fastener includes at least one locking element that is configured to center and lock the second fastener in place during the friction welding.

9. The method of claim 1, wherein rotation of the second fastener is avoided while the first fastener is rotated during friction stir welding.

10. A system for joining multiple lightweight metal sheets to a steel sheet through friction welding, the system comprising:
a first fastener that is rotated and moved along a fastener axis;
a first workpiece and a second workpiece, wherein the first workpiece and the second workpiece include a lightweight metal sheet, wherein the first fastener is driven through the first workpiece and the second workpiece, wherein the first workpiece includes an aluminum sheet or a magnesium sheet; and
a second fastener that engages the second workpiece while the first fastener is driven through the first workpiece and the second workpiece, wherein the first fastener is driven through the first workpiece and the second workpiece by friction stirring, wherein the first fastener and the second fastener are welded to form a metallurgical bond and join the first workpiece with the second workpiece.

11. The system of claim 10, wherein the first workpiece and the second workpiece include high strength lightweight metal sheets.

12. The system of claim 10, wherein rotating and moving the first fastener includes connecting a head of the first faster to a motorized tool to rotate the first fastener in a predetermined rotational direction at a predetermined speed.

13. The system of claim 10, wherein the second fastener includes a flat surface that is configured to engage a second surface of the second workpiece.

14. The system of claim 13, wherein the first fastener is moved and rotated to friction stir through the first workpiece and the second workpiece, wherein the friction stirring causes heating and softening of portions of the first workpiece and the second workpiece.

15. The system of claim 14, wherein the first fastener penetrates a first and second surface of the first workpiece and a first and second surface of the second workpiece to come in contact with a first surface of the second fastener.

16. The system of claim 10, further including an anvil that includes a cutout that is configured to accept a head of the second fastener.

17. The system of claim 10, wherein the second fastener includes at least one locking element that is configured to center and lock the second fastener in place during the friction welding.

18. The system of claim 10, wherein rotation of the second fastener is avoided while the first fastener is rotated during friction stir welding.

19. A system for joining multiple lightweight metal sheets to a steel sheet through friction welding, the system comprising:
a first steel fastener that friction stirs through multiple sheets of high strength lightweight metal; and
a second steel fastener that is positioned opposite the first steel fastener, wherein a surface of the second steel fastener is engaged by the first steel fastener and the first steel fastener is welded to the surface of the second steel fastener and joins the multiple sheets of high strength lightweight metal.

20. The system of claim 19, further including an anvil that includes a cutout that is configured to accept a head of the second fastener.
